(19) United States
(12) Patent Application Publication
(10) Pub. No.: US 2026/0277420 A1
(43) Pub. Date: Sep. 17, 2026

(54) SYSTEM AND METHOD FOR CONTINUOUS RETROSPECTIVE EVALUATION OF INTERACTIONS

(71) Applicants: Honda Motor Co., Ltd., Tokyo (JP); Cornell University, Ithaca, NY (US)

(72) Inventors: Nawid JAMALI, San Francisco, CA (US); Michael J. SACK, Ithaca, NY (US); Maria Teresa Bento PARREIRA, New York, NY (US); Xiyu FU, San Jose, CA (US); Asher M. LIPMAN, Brooklyn, NY (US); Hifza JAVED, Fremont, CA (US); Malte F. JUNG, Ithaca, NY (US)

(21) Appl. No.: 19/076,441

(22) Filed: Mar. 11, 2025

(51) Int. Cl. G06F 3/04847; G06F 3/0481; G06F 3/16

(52) U.S. Cl. CPC G06F 3/04847; G06F 3/0481; G06F 3/165

(57) ABSTRACT

A system for continuous retrospective evaluation of interactions includes a first user interface operated by a first user. The first user interface generates a recording of the first user during an interaction with a second user. The system also includes a second user interface operated by the second user. The second user interface includes a second-user-interface display that produces a playback of the recording to the second user after the interaction has ended, and includes a second-user-interface annotation tool actuated by the second user. The second-user-interface annotation tool continuously records an affect rating of the second user during the playback.

### BACKGROUND

Affect is a dynamic phenomenon, and emotional expressions in certain contexts are primarily social tools used to influence and learn about others. Observable behavior, subjective experience, and physiology all dynamically evolve across time in participants to interpersonal interactions. In such interactions, affective dynamics co-evolve with those of other interactants, correlating in ways that are yet to be fully explored.

Understanding these temporal dynamics often requires continuous data streams. While a growing body of work has addressed strategies and tools to capture affect data over time across physiology, subjective experience, and observable behavior, there is a lack of continuous research data describing how affective perceptions of others develop dynamically over time.

Despite significant efforts to develop automated methods for affect recognition, many studies still rely on human annotators to label affective states in various modalities, such as speech, text, and images. Human annotators provide a level of accuracy and nuance that is difficult to achieve with automated methods, particularly when it comes to complex emotional experiences that may not fit neatly into discrete categories. Furthermore, human annotators can provide valuable insights into the subjective experiences of individuals, enabling researchers to better understand the cognitive and social factors that shape emotional responses.

Nonetheless, manual annotation brings about its own limitations, as several factors hinder validity and reliability. For example, annotators'experience and personal perceptions, the representations chosen, and even the design of the annotation tool can affect experimental results. For example, cognitive loading by a testing apparatus may split participant attention in a manner that can render inaccurate experimental results. Consequently, there is demand for a system and method that enables researchers to reliably collect continuous affect data associated with interpersonal perceptions.

### BRIEF DESCRIPTION

According to one aspect, a system for continuous retrospective evaluation of interactions includes a first user interface operated by a first user. The first user interface generates a recording of the first user during an interaction with a second user. The system also includes a second user interface operated by the second user. The second user interface includes a second-user-interface display that produces a playback of the recording to the second user after the interaction has ended, and includes a second-user-interface annotation tool actuated by the second user. The second-user-interface annotation tool continuously records an affect rating of the second user during the playback.

According to another aspect, a method for continuous retrospective evaluation of interactions includes generating a recording of a first user during an interaction with a second user, producing a playback of the recording to the second user after the interaction has ended, and presenting an annotation tool actuated by the second user during the playback to indicate an affect rating.

According to another aspect, a non-transitory computer readable storage medium stores instructions that, when executed by a computer having a processor, causes the processor to perform a method. The method includes generating a recording of a first user during an interaction with a second user, producing a playback of the recording to the second user after the interaction has ended, and presenting an annotation tool actuated by the second user during the playback to indicate an affect rating.

### BRIEF DESCRIPTION OF THE DRAWINGS

FIG. 1 is a diagram of a system including a first user interface, a second user interface, and a third user interface.

FIG. 2 is an exemplary operating environment of the system.

FIG. 3 is an enlarged, partial view of the second user interface during an interaction between a first user and a second user.

FIG. 4 is an enlarged, partial view of the second user interface during a playback of the interaction between the first user and the second user.

FIG. 5 is a chart showing perception ratings.

FIG. 6 is an exemplary process flow for continuous retrospective evaluation of interactions using the system.

FIG. 7 is an illustration of a computer-readable medium or computer-readable device including processor-executable instructions configured to embody one or more of the provisions set forth herein, according to one aspect.

### DETAILED DESCRIPTION

The systems and methods disclosed herein are configured to facilitate dyadic interpersonal interactions, and record continuous retrospective evaluation data during playbacks of the interactions. The playbacks are produced to participants in the interactions, and the evaluation data indicates an affect rating of the participants in the interactions. The system may be further configured to facilitate continuous retrospective evaluation for both participants in the interactions, and to sequentially order playbacks of multiple interactions among a plurality of participants.

### Definitions

The following includes definitions of selected terms employed herein. The definitions include various examples and/or forms of components that fall within the scope of a term and that may be used for implementation. The examples are not intended to be limiting. Furthermore, the components discussed herein, may be combined, omitted, or organized with other components or into different architectures. “Bus,” as used herein, refers to an interconnected architecture that is operably connected to other computer components inside a computer or between computers. The bus may transfer data between the computer components. The bus may be a memory bus, a memory processor, a peripheral bus, an external bus, a crossbar switch, and/or a local bus, among others. The bus may also interconnect with components inside a device using protocols such as Media Oriented Systems Transport (MOST), Controller Area network (CAN), Local Interconnect network (LIN), among others.

“Component,” as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers. “Computer communication,” as used herein, refers to a communication between two or more communicating devices (e.g., computer, personal digital assistant, cellular telephone, network device, vehicle, connected thermometer, infrastructure device, roadside equipment) and may be, for example, a network transfer, a data transfer, a file transfer, an applet transfer, an email, a hypertext transfer protocol (HTTP) transfer, and so on. A computer communication may occur across any type of wired or wireless system and/or network having any type of configuration, for example, a local area network (LAN), a personal area network (PAN), a wireless personal area network (WPAN), a wireless network (WAN), a wide area network (WAN), a metropolitan area network (MAN), a virtual private network (VPN), a cellular network, a token ring network, a point-to-point network, an ad hoc network, a mobile ad hoc network, a vehicular ad hoc network (VANET), among others.

Computer communication may utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE, CAT-M, LoRa), satellite, dedicated short range communication (DSRC), among others. “Communication interface” as used herein may include input and/or output devices for receiving input and/or devices for outputting data. The input and/or output may be for controlling different features, components, and systems. Specifically, the term “input device” includes, but is not limited to: keyboard, microphones, pointing and selection devices, cameras, imaging devices, video cards, displays, push buttons, rotary knobs, and the like. The term “input device” additionally includes graphical input controls that take place within a user interface which may be displayed by various types of mechanisms such as software and hardware-based controls, interfaces, touch screens, touch pads or plug and play devices. An “output device” includes, but is not limited to, display devices, and other devices for outputting information and functions.

“Computer-readable medium,” as used herein, refers to a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device may read.

“Database,” as used herein, is used to refer to a table. In other examples, “database” may be used to refer to a set of tables. In still other examples, “database” may refer to a set of data stores and methods for accessing and/or manipulating those data stores. In one embodiment, a database may be stored, for example, at a disk, data store, and/or a memory. A database may be stored locally or remotely and accessed via a network.

“Data store,” as used herein may be, for example, a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD ROM). The disk may store an operating system that controls or allocates resources of a computing device.

“Display,” as used herein may include, but is not limited to, LED display panels, LCD display panels, CRT display, touch screen displays, among others, that often display information. The display may receive input (e.g., touch input, keyboard input, input from various other input devices, etc.) from a user. The display may be accessible through various devices, for example, though a remote system. The display may also be physically located on a portable device or mobility device.

“Logic circuitry,” as used herein, includes, but is not limited to, hardware, firmware, a non-transitory computer readable medium that stores instructions, instructions in execution on a machine, and/or to cause (e.g., execute) an action(s) from another logic circuitry, module, method and/or system. Logic circuitry may include and/or be a part of a processor controlled by an algorithm, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic. Similarly, where a single logic is described, it may be possible to distribute that single logic between multiple physical logics.

“Memory,” as used herein may include volatile memory and/or nonvolatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

“Module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module may also include logic, a software-controlled microprocessor, a discrete logic circuit, an analog circuit, a digital circuit, a programmed logic device, a memory device containing executing instructions, logic gates, a combination of gates, and/or other circuit components. Multiple modules may be combined into one module and single modules may be distributed among multiple modules.

“Operable connection,” or a connection by which entities are “operably connected,” is one in which signals, physical communications, and/or logical communications may be sent and/or received. An operable connection may include a wireless interface, firmware interface, a physical interface, a data interface, and/or an electrical interface.

“Portable device,” as used herein, is a computing device typically having a display screen with user input (e.g., touch, keyboard) and a processor for computing. Portable devices include, but are not limited to, handheld devices, mobile devices, smart phones, laptops, tablets, e-readers, smart speakers. In some embodiments, a “portable device” could refer to a remote device that includes a processor for computing and/or a communication interface for receiving and transmitting data remotely.

“Processor,” as used herein, processes signals and performs general computing and arithmetic functions. Signals processed by the processor may include digital signals, data signals, computer instructions, processor instructions, messages, a bit, a bit stream, that may be received, transmitted and/or detected. Generally, the processor may be a variety of various processors including multiple single and multicore processors and co-processors and other multiple single and multicore processor and co-processor architectures. The processor may include logic circuitry to execute actions and/or algorithms. The processor may also include any number of modules for performing instructions, tasks, or executables.

“User” as used herein may be a biological being, such as humans (e.g., adults, children, infants, etc.).

A “wearable computing device,” as used herein can include, but is not limited to, a computing device component (e.g., a processor) with circuitry that can be worn or attached to user. In other words, a wearable computing device is a computer that is subsumed into the personal space of a user. Wearable computing devices can include a display and can include various sensors for sensing and determining various parameters of a user. For example, location, motion, and physiological parameters, among others. Exemplary wearable computing devices can include, but are not limited to, watches, glasses, clothing, gloves, hats, helmets, visors, shirts, jewelry, rings, earrings necklaces, armbands, leashes, collars, shoes, earbuds, headphones and personal wellness devices.

### System Overview

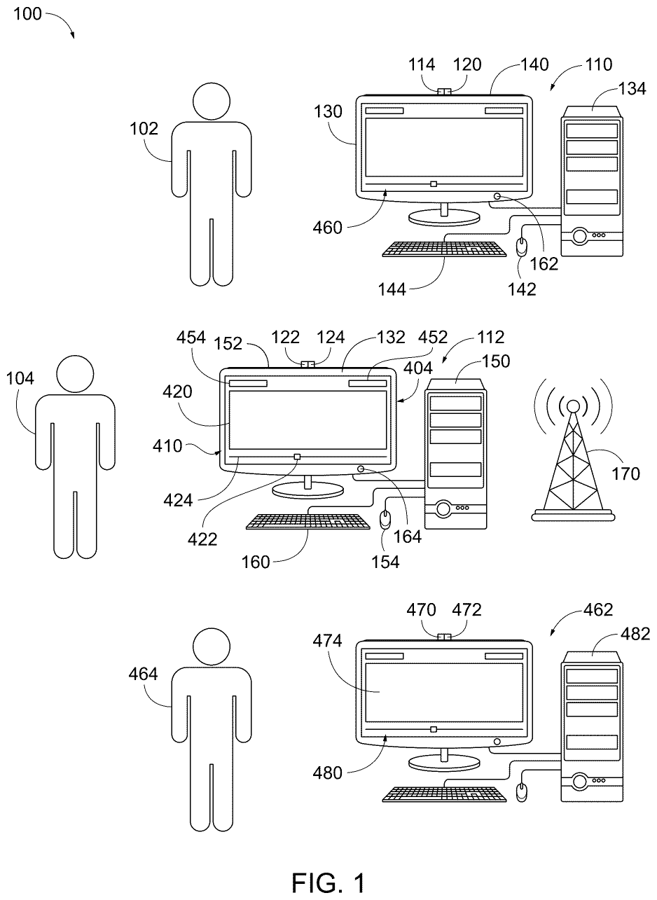

Referring now to the drawings, the drawings are for purposes of illustrating one or more exemplary embodiments and not for purposes of limiting the same. FIG. 1 depicts a system 100 for continuous retrospective evaluation of interactions between a first user 102 and a second user 104. The system 100 includes a first user interface 110 operated by the first user 102, and a second user interface 112 operated by the second user 104 for facilitating and evaluating the interaction.

The first user interface 110 includes a first-user-interface microphone 114 that generates an audio recording of the first user 102 during the interaction with the second user 104. The first user interface 110 also includes a first-user-interface camera 120 that generates a video recording of the first user 102 during the interaction with the second user 104.

The second user interface 112 includes similar features and functions in a similar manner as the first user interface 110 for facilitating and evaluating the interaction between the first user 102 and the second user 104. In this regard, the second user interface 112 includes a second-user-interface microphone 122 that generates an audio recording of the second user 104 during the interaction with the first user 102. The second user interface 112 also includes also includes a second-user-interface camera 124 that generates a video recording of the second user 104 during the interaction with the first user 102.

The first user interface 110 also includes a first-user-interface display 130 that produces a playback of the audio recording and the video recording generated by the second user interface 112 to the first user 102, after the interaction has ended. The second user interface 112 similarly includes a second-user-interface display 132 that produces a playback of the audio recording and the video recording generated by the first user interface 110 to the second user 104, after the interaction has ended. The first-user-interface display 130 and the second-user-interface display 132 may facilitate the interaction between the first user 102 and the second user 104 using video and audio information transmitted live from the first-user-interface microphone 114, the first-user-interface camera 120, the second-user-interface microphone 122, and the second-user-interface camera 124.

The first user interface 110 and components thereof are supported on a first computer 134. In this regard, the first computer 134 includes a first monitor 140 that supports the first-user-interface display 130, and includes a first mouse 142 and a first keyboard 144 for actuating the first computer 134, including elements represented on the first-user-interface display 130.

The second user interface 112 and components thereof are supported on a second computer 150. In this regard, the second computer 150 includes a second monitor 152 that supports the second-user-interface display 132, and includes a second mouse 154 and a second keyboard 160 for actuating the second computer 150, including elements represented on the second-user-interface display 132.

The first computer 134 includes a first speaker 162 configured to produce the audio recording of the first user 102 and the audio recording of the second user 104, to the first user 102 during the interaction and as part of a playback with the first-user-interface display 130 after the interaction has ended. The second computer 150 includes a second speaker 164 configured to produce the audio recording of the first user 102 and the audio recording of the second user 104 during the interaction, and as part of a playback with the second-user-interface display 132 after the interaction has ended.

As depicted, the first user interface 110 is supported on the first computer 134, which is a desktop computer, and the second user interface 112 is supported on the second computer 150, which is also a desktop computer. The first user interface 110 and the second user interface 112 may each additionally or alternatively be supported on another computing device capable of respectively supporting the components of the first user interface 110 and the second user interface 112, such as a tablet, a smartphone, a laptop computer, or wearable device without departing from the scope of the present disclosure.

In an embodiment, the first computer 134 and the second computer 150 are located remotely from each other, in separate spaces, such that the first user 102 and the second user 104 may only interact with each other through the first user interface 110 and the second user interface 112. With this this construction, the video recordings and the audio recordings respectively produced by the first user interface 110 and the second user interface 112 represent an entirety of the interaction between the first user 102 and the second user 104. As such, information obtained from the video recordings and the audio recordings respectively produced by the first user interface 110 and the second user interface 112 more accurately represent initial and subsequent impressions of the first user 102 and the second user 104 toward each other during the interaction.

The first computer 134 and the second computer 150 may communicate with each other via a network 170. In an embodiment, the system 100 is supported on a web-based browser facilitated over the network 170.

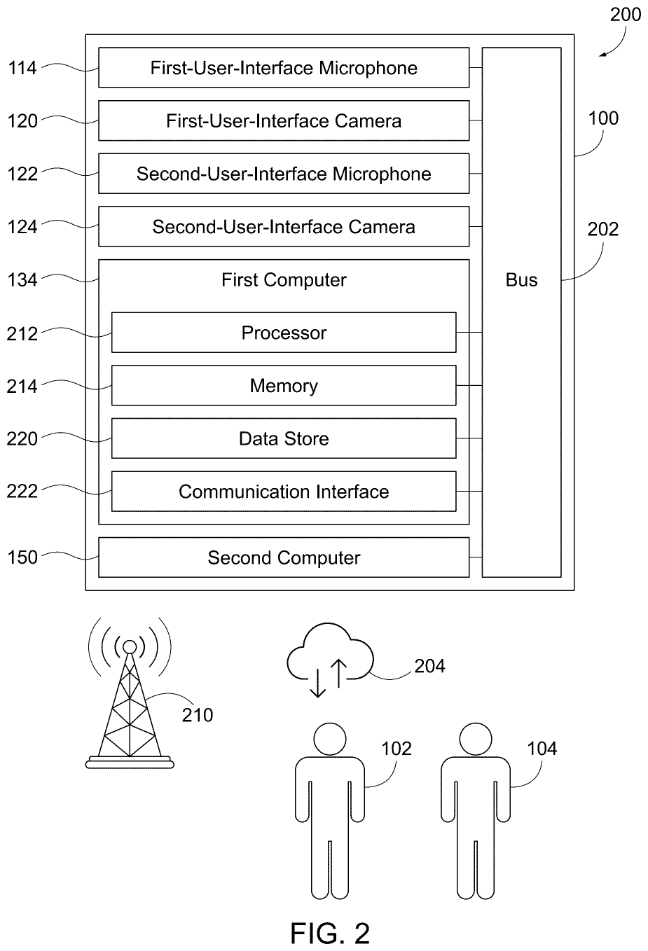

FIG. 2 depicts an exemplary component diagram of an operating environment 200 of the system 100 including the first computer 134 and the second computer 150. Each of the first computer 134 and the second computer 150, including the components of the first user interface 110 and the second user interface 112 supported thereon, are operatively connected with each other and may be interconnected by a bus 202. The components of the operating environment 200, as well as the components of other systems, hardware architectures, and software architectures discussed herein, may be combined, omitted, or organized into different architectures for various embodiments.

The first-user-interface camera 120 and the second-user-interface camera 124 are each configured to generate image data, and transmit the image data to the first computer 134 and the second computer 150. The first-user-interface camera 120 and the second-user-interface camera 124 may each include a combination of optical, infrared, or other cameras for generating the image data. The first-user-interface camera 120 and the second-user-interface camera 124 may each additionally or alternatively include light detection and ranging (LiDAR) systems, position sensors, proximity sensors, temperature sensors, and a variety of other sensors and sensor combinations for determining information on the first user 102 and the second user 104 during the interaction.

The first computer 134 and the second computer 150 are implemented as a part of the system 100, and connected to an external server 204 via a network 210. The first computer 134 and the second computer 150 may be capable of providing wired or wireless computer communications utilizing various protocols to send and receive electronic signals internally to and from components of the operating environment 200. Additionally, the first computer 134 and the second computer 150 may be operably connected for internal computer communication via the bus 202 (e.g., a Controller Area Network (CAN) or a Local Interconnect Network (LIN) protocol bus) to facilitate data input and output between the first computer 134, the second computer 150, and the components of the operating environment 200.

The first computer 134 includes a processor 212, a memory 214, a data store 220, and a communication interface 222, which are each operably connected for computer communication via the bus 202. The first communication interface 222 includes the first monitor 140, the first mouse 142, and the first keyboard 144, and provides software and hardware to facilitate data input and output between the components of the first computer 134 and other components, networks, and data sources described herein.

The second computer 150 includes similar features and functions in a similar manner as the first computer 134 for processing data and communicating with system components. In view of this, further description of components forming the second computer 150 is omitted for the sake of brevity.

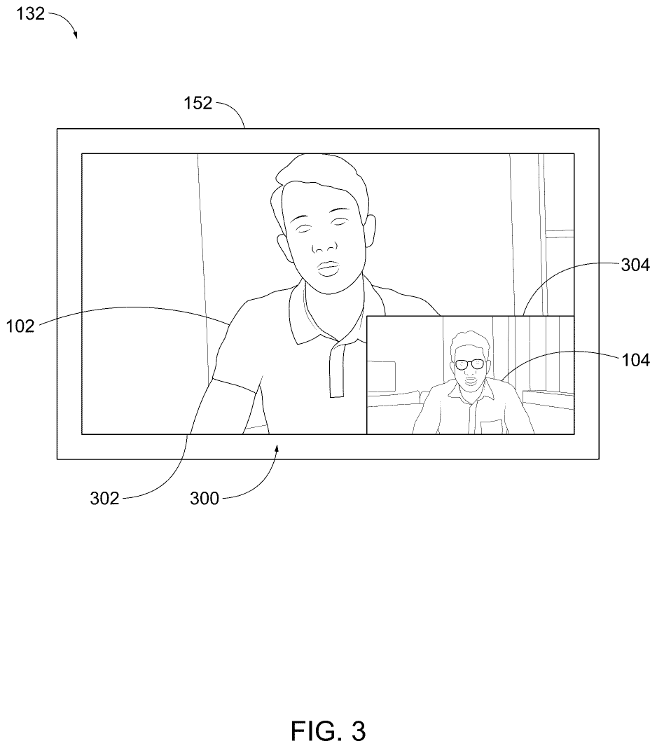

FIG. 3 depicts the second-user-interface display 132 during the interaction between the first user 102 and the second user 104. As depicted, during the interaction, the second-user-interface display 132 presents a video player 300 that facilitates the interaction live between the first user 102 and the second user 104.

The video player 300 presents a first window 302 that plays the video recording of the first user 102 as the video recording is being generated by the first-user-interface camera 120. The video player 300 also presents a second window 304 that plays the video recording of the second user 104 as the video recording is being generated by the second-user-interface camera 124. With this construction, the video player 300 presents a live video of the first user 102 and the second user 104 during the interaction, thereby facilitating the interaction.

The first-user-interface display 130 includes similar features and functions in a similar manner as the second-user-interface display 132 with respect to facilitating the interaction between the first user 102 and the second user 104. In view of this, further description of the first-user-interface display 130 in this regard is omitted for the sake of brevity.

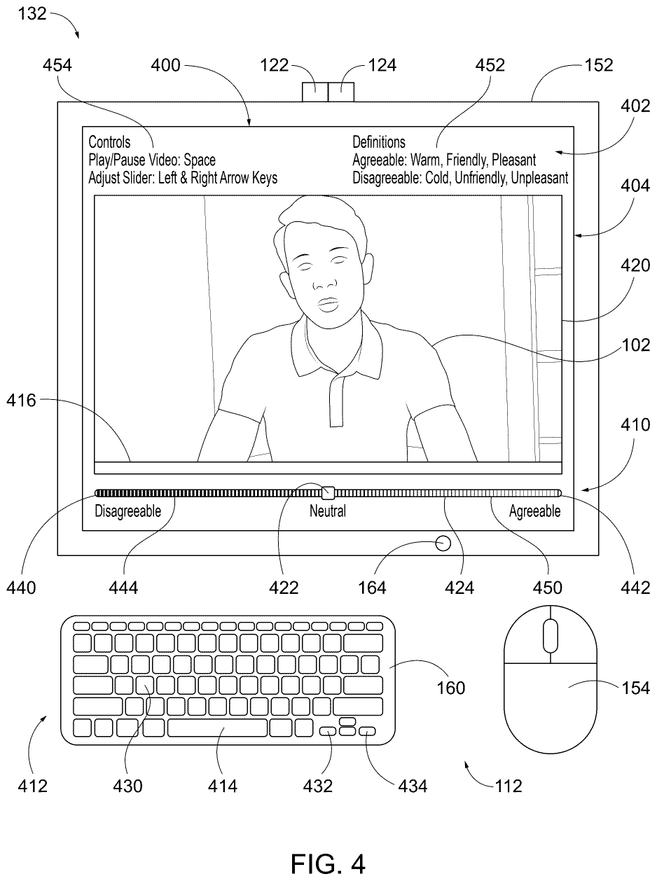

FIG. 4 depicts the second-user-interface display 132 after the interaction between the first user 102 and the second user 104 has ended. As depicted, the second-user-interface display presents an annotation dashboard 400 that includes an instruction panel 402, a video player 404, and a second-user-interface annotation tool 410. The annotation dashboard 400 is configured to produce a playback of the interaction to the second user 104.

The second keyboard 160 includes a playback control 412 operated by the second user 104. The playback 412 control enables the second user 104 to play and pause the playback, including the video recording on the video player 404, and the audio recordings from the second speaker 164. The playback control 412 includes a single button 414 operated by the second user 104 to both pause and play the playback. With this construction, the video player 404 offers minimal control features that may distract the second user 104 during the playback of the interaction.

In the depicted embodiment, the button 414 is a spacebar of the second keyboard 160. The button 414 may additionally or alternatively include any button included in the second keyboard 160, or a widget presented on the second-user-interface display 132 and accessible by the second mouse 154 for pausing and playing the playback without departing from the scope of the present disclosure.

The playback control 412 disables the second user 104 from reviewing an earlier portion of the playback once the playback has started playing. In this regard, the playback control 412 lacks any features which enable the second user 104 to play the playback in reverse, or enable the user to skip portions of the playback. With this construction, playback control 412 reduces a cognitive demand on the second user 104 evaluating the first user 102, and minimizes distractions that may divide the attention of the second user 104 during the playback.

The video player 404 also includes a progress bar 416 that indicates a progression of the playback as a proportion of an entire length of the playback. The progress bar 416 is not a widget configured for being actuated by the second user 104. The progress bar 416 occupies a minimal portion of the video player 404, along a bottom side 418 of the video player 404. As such, the progress bar 416 features a minimal design that informs the second user 104 of an amount of progress made in viewing the playback. With this construction, the progress bar 416 and minimizes an amount of attention from the second user 104, while still informing the second user 104 on the amount of progress made in viewing the playback.

With continued reference to FIG. 4, the playback presented in the second-user-interface display 132 does not include any video recording of the second user 104. In this regard, the video player 404 includes a single window 420 that presents the video recording of the first user 102 to the second user 104. With this construction, the second user 104 is relatively less likely to watch and direct attention toward themselves in the interaction, and relatively more likely to watch and direct attention toward the first user 102 in the interaction. Consequently, the second user 104 will more naturally concern themselves with performance by the first user 102 when retrospectively evaluating the interaction. Notably, causing the second user 104 to evaluate the interaction retrospectively prevents the second user 104 from dividing their attention between interacting with the first user 102 and evaluating the first user 102, including operating tools for recording the evaluation.

The second-user-interface annotation tool 410 may be actuated by the second user 104 using the second mouse 154, where the second mouse 154 corresponds to a cursor on the second-user-interface display 132. In this regard, the second mouse 154 is configured to click and drag a slider 422 disposed on a scale 424 of the second-user-interface annotation tool 410. The slider 422 travels along the scale 424 at a speed corresponding to travel by the second mouse 154, up to a maximum speed controlled by the second-user-interface annotation tool 410. With this construction, the second user 104 is limited with respect to a change rate of an affect rating generated by the second-user-interface annotation tool 410.

The second-user-interface annotation tool 410 may additionally or alternatively be actuated using keys 430 on the second keyboard 160, such as a left arrow key 432 and a right arrow key 434. In such an embodiment, the left arrow key 432 and the right arrow key 434 respectively correspond with a first end 440 that is a left end, and a second end 442 that is a right end of the scale 424. Pressing one of the keys 430, such as the left arrow key 432 and the right arrow key 434, moves the slider 422 along the scale 424 in a corresponding direction by a predetermined increment. Holding one of the keys 430 moves the slider 422 along the scale 424 in a corresponding direction at a predetermined rate of travel. While, as depicted, the second-user-interface annotation tool 410 may be actuated by the second keyboard 160 and presented on the second-user-interface display 132, the second-user-interface annotation tool 410 may additionally or alternatively be actuated by a physical switch, slide scale, dial, or other electromechanical device external to and connected with the second computer 150 for recording the affect rating by the second user 104.

With continued reference to FIG. 4, during the playback produced by the second user interface 112, the second-user-interface annotation tool 410 continuously records an affect rating of the second user during the playback, the affect rating corresponding to a position of the slider 422 along the scale 424. The slider 422 is static on the scale 424 when not being moved by the second user 104. With this construction, the second-user-interface annotation tool 410 maintains an affect rating most recently set by the second user 104 during the playback, and continuously records the most recently set affect rating during the playback. With this construction, the annotation tool 410 avoids causing fatigue in the second user 104 by requiring less active input from the second user 104.

The annotation tool 410 records the affect rating continuously, at predetermined intervals of time. In an embodiment, the predetermined intervals correspond to a framerate of the playback produced by the second user interface 112. The annotation tool 410 also records any change in the affect rating, and compares the recorded change in the affect rating to the continuously recorded affect rating to ensure accuracy in the recordings.

The second-user-interface display 132 presents the second-user-interface annotation tool 410 below the video player 404 on a single screen of the second monitor 152, with no other user-controlled widgets located between the second-user-interface annotation tool 410 and the video player 404. Also, the second-user-interface annotation tool 410 includes only one slide scale, that is the slide scale 424, which corresponds to a single affect rating by the second user 104. Further, the second-user-interface display 132 presents only one widget, i.e. the annotation tool 410, for recording an affect rating by the second user 104 at a time. With this construction, attention by the second user 104 is relatively focused toward the video recording of the second user 104 and the annotation tool 410 during the playback.

With continued reference to FIG. 4, the annotation tool 410 is discretized over a number range having negative values and positive values. As depicted, the first end 440 of the scale 424 corresponds to a value of negative 7, and the second end 442 corresponds to a value of positive 7. With this construction, the scale 424 has an absolute range of fifteen, centered on zero. While, as depicted, the scale 424 has an overall range of fifteen, the scale 424 may have a larger or smaller absolute range without departing from the scope of the present disclosure. Further, the slider 422 may travel along the scale 424 at minimum increments that are fractional values between whole integers.

In an alternative embodiment, the scale 424 does not have fixed ends, such that the second user 104 may record an affect value indefinitely beyond negative 7 and positive 7.

The annotation tool 410, particularly the scale 424, is color coded. In this regard, a first end portion 444 of the scale 424 associated with the negative values is red, and a second end portion 450 of the scale 424 is associated with the positive values is green. The first end portion 444 and the second end portion 450 transition in color from red to green with a color gradient centered on zero, a neutral value.

The first end 440 of the scale 424 and the second end 442 of the scale 424 are each labeled with a dimension of the affect being evaluated. More specifically, and by way of example, the first end 440 is labeled “Disagreeable” and the second end 442 is labeled “Agreeable” to indicate agreeableness as the affect rating.

The affect rating recorded by the annotation tool 410 describes a social aspect of the first user 102 experienced by the second user 104 during the interaction, retrospectively recorded by the second user 104 during the playback on the second user interface 112. In the depicted embodiment, the second-user-interface display 132 presents the affect rating as an agreeableness of the first user 102 toward the second user 104 during the interaction. The affect rating may alternatively describe a variety of individual aspects or personality traits of the first user 102 experienced by the second user 104 during the interaction, such as, for example, conscientiousness, creativity, loyalty, openness, ambition, honesty, courage, confidence, gratitude, empathy, curiosity, and amicability without departing from the scope of the present disclosure. With this construction, the annotation tool 410 focuses on a dimension of approach and withdrawal by the first user 102 toward the second user 104 during the interaction, indicating a degree to which behavior by the first user 102 is seen as increasing or decreasing social distance over time.

The second-user-interface display 132 presents the instruction panel 402 above the video player 404. As depicted, the instruction panel 402 describes controls 452 actuatable by the second user 104, including how to actuate the annotation tool 410 and the playback control 412. The instruction panel 402 also describes a significance of the affect rating with definitions 454 for agreeableness in terms of outward behavior qualities which typically correspond to agreeable and disagreeable natures.

Notably, by presenting the instruction panel 402, the video player 404, and the second-user-interface annotation tool 410 with minimal design features, the system 100 is intuitive and mitigates a requirement for training participants such as the first user 102 and the second user 104 prior to using the system 100. As such, the system 100 enables dedicating more time to facilitating and evaluating the interaction.

The first user interface 110 and the second user interface 112 include similar features and function in a similar manner for producing a playback of an interaction and retroactively recording an affect rating by a user associated with the playback. In this regard, as shown in FIG. 1, the first user interface 110 includes a first-user-interface slide adjustment 460 presented in the first-user-interface display 130. The first-user interface display 130 and the first-user-interface slide adjustment 460 respectively include similar features and function in a similar manner as the second-user-interface display 132 and the second-user-interface annotation tool 410 for producing the playback of the interaction to the first user 102 and retroactively recording an affect rating by the first user 102.

With continued reference to FIG. 1, the system 100 includes a third user interface 462 operated by a third user 464. The third user interface 462 includes similar features and functions in a similar manner as the first user interface 110 and the second user interface 112 for facilitating a dyadic interaction with another user, such as one of the first user 102 and the second user 104, for producing a playback of the interaction and retroactively recording an affect rating by the third user 464 associated with the playback.

In this regard, the third user interface 462 includes a third-user-interface microphone 470 that generates an audio recording of the third user 464 during an interaction with the second user 104. The third user interface 462 also includes a third-user-interface camera 472 that generates a video recording of the third user 464 during the interaction with another user. The third user interface 462 also includes a third-user-interface display 474 that produces a playback of an audio recording and a video recording generated by another user interface, such as one of the first user interface 110 and the second user interface 112, after the interaction has ended. The third user interface 462 also includes a third-user-interface annotation tool 480 actuated by the third user 464. The third-user-interface annotation tool 480 continuously records an affect rating of the third user 464 during the playback. The third user interface 462 and components thereof are supported on a third computer 482 that includes similar features and functions in a similar manner as the first computer 134 an the second computer 150.

In an embodiment where the first user interface 110 and the second user interface 112 facilitate the interaction between the first user 102 and the second user 104, and the second user interface 112 and the third user interface 462 facilitate an interaction between the second user 104 and the third user 464, the second-user-interface display 132 produces a first playback from the audio recording and the video recording generated by the first user interface 110, and then produces a second playback from the audio recording and the video recording generated by the third user interface 462, subsequent to the first playback. As described above, the third-user-interface microphone 470, the third-user-interface camera 472, the third-user-interface display 474, and the third-user-interface annotation tool 480 include similar features and function in a similar manner as the first-user-interface microphone 114, the first-user-interface camera 120, the first-user-interface display 130, and the first-user-interface annotation tool 460. In view of this, further description is omitted for the sake of brevity.

While, as depicted, the first user interface 110, the second user interface 112, and the third user interface 462 each include a camera and a microphone for supporting an audiovisual interaction between the first user 102, the second user 104, and the third user 464, each of the first user interface 110, the second user interface 112, and the third user interface 462 may additionally or alternatively include a variety of components that respectively receive a variety of user inputs from the first user 102, the second user 104, and the third user 464 for facilitating interactions and producing corresponding playbacks without departing from the scope of the present disclosure. For example, the first user interface 110, the second user interface 112, and the third user interface 462 may respectively receive text inputs from the first user 102, the second user 104, and the third user 464, and transmit or produce the text inputs as part of a playback. As another example, the first user interface 110, the second user interface 112, and the third user interface 462 may respectively receive audio inputs without corresponding video input from the first user 102, the second user 104, and the third user 464, and transmit or produce the audio inputs as part of a playback.

An exemplary embodiment of the system 100 was employed in an experimental procedure where participants were recorded while interacting to solve a task. When the participants reached an agreement, or after 10 minutes of discussion had elapsed, whichever occurred sooner, the participants were asked to stop their discussion and fill out a survey. The survey collected demographic data, as well as measures of interpersonal affect from the participants.

The system 100 merged video recording and audio recording of the participants during the discussion, and transmitted the merged video recording and audio recording as a playback. Each participant was then distributed a unique URL which opened a browser supporting the system 100, including the instruction panel 402, the video player 404, and the second-user-interface annotation tool 410. Participants were each presented with a video of their discussion partner on the video player 404 and were asked to continuously rate how their partner came across moment-to-moment using the second-user-interface annotation tool 410.

The task solved by the participants using the system 100 required that the participants rank order a list of “reasons for poverty” according to their “accuracy.” Half of the items to be ranked follow a reasoning that sees the source of poverty in peoples'situation, i.e., their circumstances, whereas the other half follows a reasoning that sees the source of poverty in peoples'disposition, i.e., their personality. By strategically recruiting participants with opposing beliefs about poverty, the experiment was designed to elicit an emotionally engaging interaction. The participants were provided the following instructions:

You and the other participant must come to an agreement as to a rank of the 5 most relevant causes of poverty in order of the accuracy of each statement. The cause of poverty that is evaluated as being most accurate will be ranked as 1st, and the one that is evaluated as least accurate will be ranked as 5th.
Poor people lack the ability to manage money.
Poor people waste their money on inappropriate items.
Poor people do not actively seek to improve their lives.
Poor people lack talents and abilities.
Poor people are exploited by the rich.
The society lacks justice.
Distribution of wealth in society is uneven.
Poor people lack opportunities because they live in poor families.
Poor people live in places where there are not many opportunities.
Poor people have encountered personal misfortunes, which limit their opportunities.
Poor people are discriminated against in society.
Poor people have bad fate.
Poor people lack luck.

Participants were given a maximum of ten minutes to address the prompt above. Limiting the discussion to ten minutes prevented the participants from becoming disengaged or fatigued when reviewing the discussion on the playback.

To evaluate how participants are interacting with the platform, the system 100 measured a click rate that is an interval of time between rating data points, and a rating range that is a range of values for one retrospective annotation session. To measure user experience, participants were surveyed for feedback about their interactions with the system 100 in an exit survey.

Measures of interpersonal agreeableness (IA) and interpersonal perception (IP) generated using the system 100 were compared to evaluate the effectiveness of the system 100 in accurately capturing an individual's assessment of the interaction.

The IA measure was operationalized by asking participants “How did the other participant come across?” on a 7-point Likert scale (from disagreeable to agreeable) in the exit survey. The IP measure was operationalized from the continuous interpersonal affect rating data generated by the second-user-interface annotation tool 410. The resolution of the rating data was set to a 0.1 s period (10 Hz), to ease manipulation of the data within and across sessions. Then, to calculate the IP for each participant, a cumulative sum of the ratings during the discussion were fitted with a linear regression to that data. The Interpersonal IP measure is given by the slope of that regression, providing an understanding of how the perception of the other participant evolved over the discussion.

The exit survey collected demographic information including age, gender, nationality, and race/ethnicity. The exit survey also collected personality traits of the participants, collected self-reported ratings of their religiousness ranging from not-at-all religious to very religious, and collected political leaning very liberal to very conservative with 7-point Likert scales.

A total of 12 interaction sessions (24 participants) were used for the procedure, with an average interaction duration of 560.01±111.39 seconds. A total length of interaction data was 13,440.22 seconds, around 224 minutes. Participants'age ranged from 20-61 years (M±SD: 39.75±13.49). Out of the 24 participants, 13 identified as female, and 11 identified as male. Race/ethnicity among participants was mostly Caucasian/White (17), followed by Asian/Asian American (4), Hispanic/Latino (4) and African/African American/Black (2) (participants could select multiple). Most participants were native speakers of English (21), with 3 proficient users.

In the procedure, participants'average click rate was 0.42±0.02 seconds. Each discussion had an average of 1,116±222 rating data points. The scale 424 ranges from −7 (disagreeable) to +7 (agreeable).

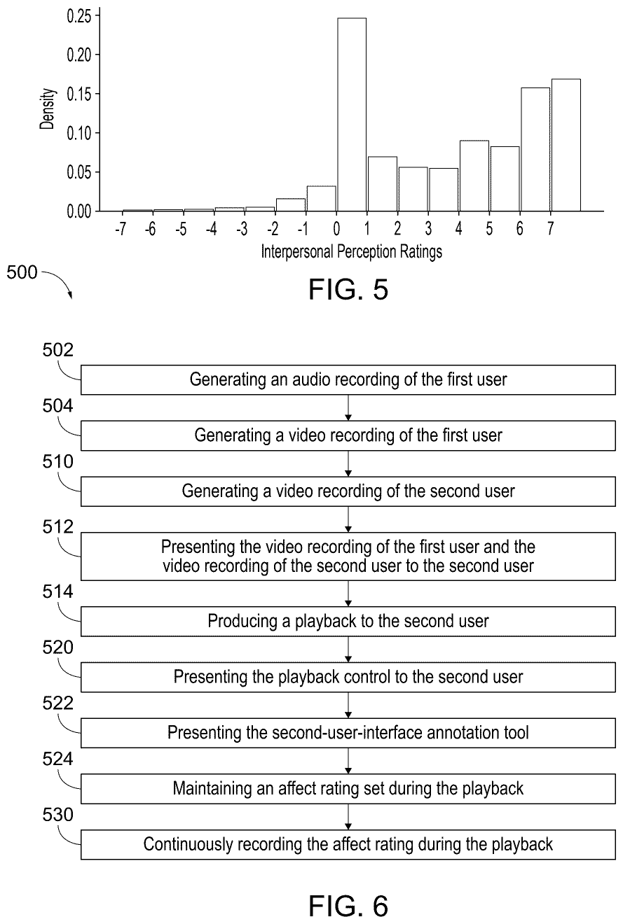

With reference to FIG. 5, for the discussions analyzed, the average rating range was 8.08. Voluntary open-response questions in our exit survey revealed an overall positive annotation experience as reported by users. Given that these questions were open-response and inquired broadly about experiences with the study, respondents, in general, detailed both positive and negative aspects of their interaction during the discussion task rather than with the platform itself. Three (3) participants spoke explicitly to “ease of use” experienced with the system 100, and seven (7) reported the platform design of the system 100 to be “clear”, “intuitive”, or some variation thereof. With these results, the exit survey indicates the system to be accurate, engaging, and intuitive to use by participants.

### Methods for Operating the Information Generation System

Referring to FIG. 6, a method for continuous retrospective evaluation of interactions will be described according to an exemplary embodiment. FIG. 6 will be described with reference to FIG. 1-5. For simplicity, the method 500 will be described as a sequence of blocks, but the elements of the method 500 may be organized into different architectures, elements, stages, and/or processes.

At block 502, the method 500 includes generating an audio recording of the first user 102 during the interaction with the second user 104. At block 504, the method 500 includes generating a video recording of the first user 102 during the interaction with the second user 104. At block 510, the method 500 includes generating a video recording of the second user 104 during the interaction.

At block 512, the method 500 includes presenting the video recording of the first user 102 and the video recording of the second user 104 to the second user 104 during the interaction. At block 514, the method 500 includes producing a playback of the audio recording and the video recording to the second user 104, after the interaction has ended. In an embodiment, producing the playback does not include presenting the video recording of the second user 104 to the second user 104.

At block 520, the method 500 includes presenting the playback control 412 operated by the second user 104. The playback control 412 includes a single button 414 that enables the second user 104 to both play and pause the playback, and the playback control 412 disables the second user 104 from reviewing an earlier portion of the playback once the playback has started playing. At block 522, the method 500 includes presenting the second-user-interface annotation tool 410 actuated by the second user 104 during the playback to indicate an affect rating. In an embodiment, presenting the second-user-interface annotation tool 410 includes presenting a single slider 422 that corresponds to a single affect rating by the second user 104, and presenting only one widget for recording an affect rating by the second user 104 at a time.

At block 524, the method 500 includes maintaining an affect rating most recently set by the second user 104 during the playback. At block 530, the method 500 includes continuously recording the affect rating during the playback using the second-user-interface annotation tool 410.

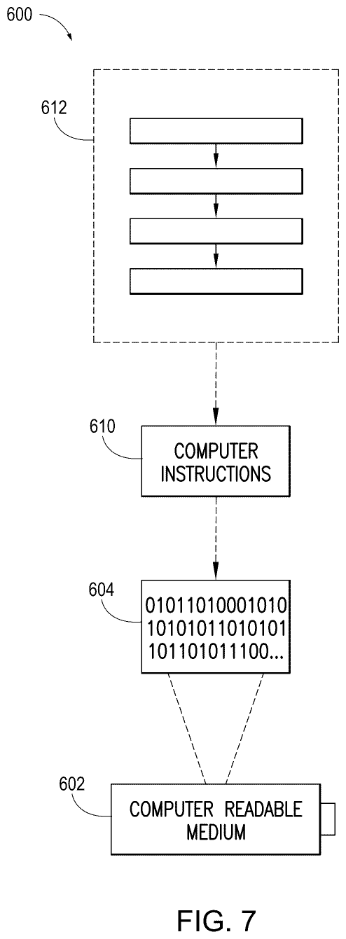

Still another aspect involves a non-transitory computer-readable medium including processor-executable instructions configured to implement one aspect of the techniques presented herein. An aspect of a computer-readable medium or a computer-readable device devised in these ways is illustrated in FIG. 7, where an implementation 600 includes a computer-readable medium 602, such as a CD-R, DVD-R, flash drive, a platter of a hard disk drive, etc., on which is encoded computer-readable data 604. This encoded computer-readable data 604, such as binary data including a plurality of zero's and one's as shown in 604, in turn includes a set of processor-executable computer instructions 610 configured to operate according to one or more of the principles set forth herein. In this implementation 600, the processor-executable computer instructions 610 may be configured to perform a method 612, such as the method 500 of FIG. 6. In another aspect, the processor-executable computer instructions 610 may be configured to implement a system, such as the operating environment 200 of FIG. 2. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Although the subject matter has been described in language specific to structural features or methodological acts, it is to be understood that the subject matter of the appended claims is not necessarily limited to the specific features or acts described above. Rather, the specific features and acts described above are disclosed as example aspects. Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A system for continuous retrospective evaluation of interactions, the system comprising:
a first user interface operated by a first user, wherein the first user interface generates a recording of the first user during an interaction with a second user; and
a second user interface operated by the second user, the second user interface including:
a second-user-interface display that produces a playback of the recording to the second user after the interaction has ended; and
a second-user-interface annotation tool actuated by the second user, wherein the second-user-interface annotation tool continuously records an affect rating of the second user during the playback.

2. The system of claim 1, wherein the second-user-interface annotation tool includes only one scale that corresponds to a single affect rating by the second user, and the second-user-interface display presents only one widget for recording an affect rating by the second user at a time.

3. The system of claim 1, wherein the second-user-interface display includes a second-user-interface playback control operated by the second user, wherein the second-user-interface playback control enables the second user to play and pause the playback, and disables the second user from reviewing an earlier portion of the playback once the playback has started playing.

4. The system of claim 3, wherein the second-user-interface playback control includes a single button operated by the second user to pause and play the playback.

5. The system of claim 1, wherein the affect rating describes a social aspect of the first user experienced by the second user during the interaction, retrospectively recorded by the second user during the playback.

6. The system of claim 5, wherein the display presents the affect rating as an agreeableness of the first user toward the second user during the interaction.

7. The system of claim 5, wherein the second-user-interface annotation tool is discretized over a number range having negative values and positive values, and
the second-user-interface annotation tool is color coded with a first end portion of the second-user-interface annotation tool associated with the negative values being a first color, and a second end portion of the second-user-interface annotation tool associated with the positive values being a second color, and the second-user-interface annotation tool transitions from first color to the second color with a color gradient centered on a neutral value.

8. The system of claim 1, wherein the second-user-interface annotation tool maintains an affect rating most recently set by the second user during the playback, and continuously records the most recently set affect rating during the playback.

9. The system of claim 1, wherein the first user interface includes a first-user-interface microphone that generates an audio recording of the first user during the interaction with a second user, and a first-user-interface camera that generates a video recording of the first user during the interaction with the second user.

10. The system of claim 9, wherein the second-user-interface display presents the second-user-interface annotation tool below a video player on a single screen, with no other user-controlled widgets located between the second-user-interface annotation tool and the video player, wherein the video player is configured to produce the video recording generated by the first-user-interface in the playback.

11. The system of claim 9, wherein the second user interface includes a second-user-interface camera that generates a video recording of the second user during the interaction, and
during the interaction, the first-user-interface display presents a first window that plays the video recording of the first user, and presents a second window that plays the video recording of the second user.

12. The system of claim 11, wherein the playback does not include any video recording of the second user.

13. The system of claim 9, wherein the second user interface includes a second-user-interface microphone that generates an audio recording of the second user during the interaction, and includes a second-user-interface camera that generates a video recording of the second user during the interaction,
the first user interface includes a first-user-interface display that produces a playback of the audio recording from the second-user-interface microphone and the video recording from the second-user-interface camera to the first user, and
the first-user-interface display includes a first-user-interface annotation tool actuated by the first user, wherein the first-user-interface annotation tool continuously records a second affect rating associated with the playback from the first display.

14. The system of claim 9, further comprising:
a third user interface operated by a third user, the third user interface including:
a third-user-interface microphone that generates an audio recording of the third user during an interaction with the second user; and
a third-user-interface camera that generates a video recording of the third user during the interaction with the second user,
wherein the second-user-interface display produces a first playback from the audio recording and the video recording generated by the first user interface, and produces a second playback from the audio recording and the video recording generated by the third user interface, subsequent to the first playback.

15. A method for continuous retrospective evaluation of interactions, the method comprising:
generating a recording of a first user during an interaction with a second user;
producing a playback of the recording to the second user after the interaction has ended; and
presenting an annotation tool actuated by the second user during the playback to indicate an affect rating.

16. The method of claim 15, further comprising maintaining an affect rating most recently set by the second user during the playback, and continuously recording the affect rating during the playback.

17. The method of claim 15, wherein presenting the annotation tool includes presenting a single slider that corresponds to a single affect rating by the second user, and presenting only one widget for recording an affect rating by the second user at a time.

18. The method of claim 15, further comprising presenting a playback control operated by the second user, wherein the playback control includes a single button that enables the second user to both play and pause the playback, and the playback control disables the second user from reviewing an earlier portion of the playback once the playback has started playing.

19. The method of claim 15, further comprising:
generating a video recording of the first user during the interaction;
generating a video recording of the second user during the interaction; and
presenting the video recording of the first user and the video recording of the second user to the second user during the interaction,
wherein producing the playback does not include presenting the video recording of the second user to the second user.

20. A non-transitory computer readable storage medium storing instructions that, when executed by a computer having a processor, causes the processor to perform a method, the method comprising:
generating a recording of a first user during an interaction with a second user;
producing a playback of the recording to the second user after the interaction has ended; and
presenting an annotation tool actuated by the second user during the playback to indicate an affect rating.
